(19) United States
(12) Patent Application Publication
(10) Pub. No.: US 2026/0249663 A1
(43) Pub. Date: Aug. 27, 2026

(54) THERMAL MANAGEMENT SYSTEM

(71) Applicant: SANDEN CORPORATION, Gunma (JP)

(72) Inventor: Nobutaka SHIMIZU, Isesaki-shi (JP)

(73) Assignee: SANDEN CORPORATION, Gunma (JP)

(21) Appl. No.: 19/489,720

(22) PCT Filed: May 22, 2024
(86) PCT No.: PCT/JP2024/018813

§ 371 Date: Dec. 3, 2025

(30) Foreign Application Priority Data
Jun. 20, 2023 (JP) 2023-100904

(51) Int. Cl. B60H 1/00; F28D 21/00

(52) U.S. Cl. CPC B60H 1/00899; B60H 1/00278; F28D 2021/0091

(57) ABSTRACT

Provided is a thermal management system that makes it easy to control a dehumidification amount and a blower air temperature to the inside of a vehicle cabin in a dehumidification heating operation. A low-temperature-side heat medium circuit 30 includes a proportional control valve V 31 disposed downstream of a cooler core 31, and when the dehumidification heating operation is performed in the vehicle cabin, in a high-temperature-side heat medium circuit 20, a heat medium circulates between a high-temperature-side heat exchanger 12 and a heater core 21, a channel switching device 70 connects the low-temperature-side heat medium circuit 30 and an outdoor heat exchange circuit 60, and the proportional control valve V 31 is capable of dividing the heat medium having flowed through the cooler core 31 into a first channel through which the heat medium having flowed through the cooler core 31 flows to downstream of a radiator 61 and upstream of a low-temperature-side heat exchanger 14 and a second channel through which the heat medium having flowed through the cooler core 31 flows to the radiator 61.

### TECHNICAL FIELD

The present invention relates to a thermal management system.

### BACKGROUND ART

In recent years, use of electric vehicles has increased. In the electric vehicle, the power of a battery is also used for temperature adjustment of the inside of a vehicle cabin, various in-vehicle devices, and the like. In order to ensure a sufficient travel distance by the charged battery, it is necessary to efficiently use the power. For example, Patent Literature 1 discloses a technique related to a thermal management system having a refrigerant circuit and a heat medium circuit.

### CITATION LIST

### Patent Literature

Patent Literature 1: JP-A-2022-180136

### SUMMARY OF INVENTION

### Problems to be Solved by Invention

An object of the present invention is to provide a thermal management system that makes it easy to control a dehumidification amount and a blower air temperature in a dehumidification heating operation.

### Solution to Problems

According to one aspect of the present invention, a thermal management system includes a refrigerant circuit configured to circulate refrigerant and including a compressor, a high-temperature-side heat exchanger, a decompression device, and a low-temperature-side heat exchanger, a high-temperature-side heat medium circuit including a heater core that heats air supplied into a vehicle cabin and configured to circulate a heat medium capable of exchanging heat with the refrigerant via the high-temperature-side heat exchanger, a low-temperature-side heat medium circuit including a cooler core that cools air supplied into the vehicle cabin and configured to circulate a heat medium capable of exchanging heat with the refrigerant via the low-temperature-side heat exchanger, a heat absorbing target heat exchange circuit including a heat exchanger for a heat absorbing target and configured to circulate a heat medium, and a channel switching device configured to switch the low-temperature-side heat medium circuit and the heat absorbing target heat exchange circuit between a connection state and an independent state, the low-temperature-side heat medium circuit includes a flow divider for a heat medium, which is disposed downstream of the cooler core, and when a dehumidification heating operation is performed in the vehicle cabin, in the high-temperature-side heat medium circuit, a heat medium circulates between the high-temperature-side heat exchanger and the heater core, the channel switching device connects the low-temperature-side heat medium circuit and the heat absorbing target heat exchange circuit, and the flow divider is capable of dividing a heat medium having flowed through the cooler core into a first channel through which the heat medium having flowed through the cooler core flows to the low-temperature-side heat exchanger without passing through the heat exchanger for the heat absorbing target and a second channel through which the heat medium having flowed through the cooler core flows to the low-temperature-side heat exchanger via the heat exchanger for the heat absorbing target.

### Effects of Invention

According to the present invention, the thermal management system can be provided, which makes it easy to control the dehumidification amount and the blower air temperature to the inside of a vehicle cabin in the dehumidification heating operation.

### BRIEF DESCRIPTION OF DRAWINGS

FIG. 1 is a schematic diagram of a configuration example of a thermal management system according to one embodiment, which shows an example of the state of the thermal management system when a cooling operation is performed.

FIG. 2 is a schematic diagram of a configuration example of the thermal management system according to one embodiment, which shows an example of the state of the thermal management system when a dehumidification heating operation is performed.

FIG. 3 is a schematic diagram of a configuration example of the thermal management system according to one embodiment, which shows an example of the state of the thermal management system when the dehumidification heating operation is performed.

FIG. 4 is a schematic diagram of a configuration example of the thermal management system according to one embodiment, which shows an example of the state of the thermal management system when the dehumidification heating operation is performed.

FIG. 5 is a schematic diagram of a configuration example of the thermal management system according to one embodiment, which shows an example of the state of the thermal management system when the dehumidification heating operation is performed.

### DESCRIPTION OF EMBODIMENTS

### First Embodiment

A first embodiment will be described.

### Configuration of System

### <Outline of System>

One embodiment as the first embodiment will be described with reference to the drawings. The present embodiment relates to a thermal management system having a refrigerant circuit and a heat medium circuit. The thermal management system of the present embodiment is mounted on an electric vehicle, and is capable of performing a cooling operation according to the situation.

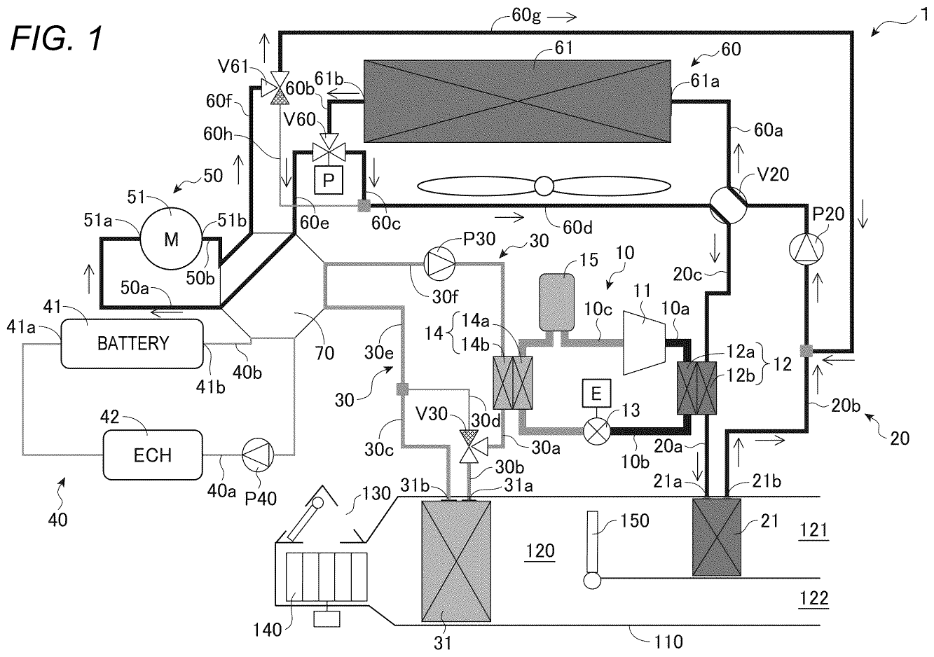

FIG. 1 is a schematic diagram for describing a configuration example of a thermal management system 1 according to the present embodiment. The thermal management system 1 is configured such that a circuit is switched according to various operations. FIG. 1 shows a circuit configuration during the cooling operation among various operations. Note that an arrow in the figure indicates a direction in which a heat medium flows.

The thermal management system 1 includes a refrigerant circuit 10 configured to circulate refrigerant. The refrigerant is not limited thereto, and for example, hydrofluoroolefin or the like may be used. Further, the thermal management system 1 includes a high-temperature-side heat medium circuit 20, a low-temperature-side heat medium circuit 30, a battery temperature adjustment circuit 40, a motor temperature adjustment circuit 50, and an outdoor heat exchange circuit 60, which are configured to circulate a heat medium as fluid such as a coolant, for example. Among these circuits, the low-temperature-side heat medium circuit 30, the battery temperature adjustment circuit 40, the motor temperature adjustment circuit 50, and the outdoor heat exchange circuit 60 are connected to a channel switching device 70 as a first channel switching device, such as an eight-way valve. The channel switching device 70 can couple these channels to each other to form a circulation path in which these circuits cooperate to circulate the heat medium, or disconnect one or more circuits from other circuits to independently operate these circuits. The high-temperature-side heat medium circuit 20 and the outdoor heat exchange circuit 60 are connected to a channel switching device as a second channel switching device, such as a four-way valve V20, that connects or disconnects the channels to or from each other. The four-way valve V20 can form the circulation path in which the high-temperature-side heat medium circuit 20 and the outdoor heat exchange circuit 60 cooperate to circulate the heat medium, or can disconnect these circuits from each other.

Further, the thermal management system 1 includes a heating, ventilation, and air conditioning (HVAC) unit 100. In addition, the thermal management system 1 includes various sensors (not shown) and a control device that controls operation of each unit of the thermal management system 1. The operation of the thermal management system 1 is controlled based on detection values of the various sensors, various requests, and the like.

### <Refrigerant Circuit>

The refrigerant circuit 10 includes a compressor 11 that compresses gaseous refrigerant into high-temperature high-pressure refrigerant and then discharge the high-temperature high-pressure refrigerant, a high-temperature-side heat exchanger 12 that condenses the compressed gaseous refrigerant to dissipate heat, a decompression device 13, such as an expansion valve, that expands liquid refrigerant into low-pressure refrigerant, and a low-temperature-side heat exchanger 14 that evaporates the low-temperature low-pressure liquid refrigerant to absorb heat. The refrigerant circuit 10 is configured to function as a heat pump that circulates the refrigerant and repeats compression, condensation, expansion, and evaporation.

In the high-temperature-side heat exchanger 12, the refrigerant exchanges heat with the heat medium circulating in the high-temperature-side heat medium circuit 20. Moreover, in the low-temperature-side heat exchanger 14, the refrigerant exchanges heat with the heat medium circulating in the low-temperature-side heat medium circuit 30.

In the example shown in the figures, the high-temperature-side heat exchanger 12 includes a refrigerant passage 12a through which the refrigerant circulating in the refrigerant circuit 10 passes, and a heat medium passage 12b through which the heat medium circulating in the high-temperature-side heat medium circuit 20 passes. The low-temperature-side heat exchanger 14 includes a refrigerant passage 14a through which the refrigerant circulating in the refrigerant circuit 10 passes, and a heat medium passage 14b through which the heat medium circulating in the low-temperature-side heat medium circuit 30 passes.

The elements of the refrigerant circuit 10 are connected by refrigerant channels 10a, 10b, 10c. The compressor 11 is connected to the inlet of the refrigerant passage 12a of the high-temperature-side heat exchanger 12 by the refrigerant channel 10a. The outlet of the refrigerant passage 12a of the high-temperature-side heat exchanger 12 is connected to the inlet of the refrigerant passage 14a of the low-temperature-side heat exchanger 14 by the refrigerant channel 10b, and the decompression device 13 such as an expansion valve is placed on the path of the refrigerant channel 10b. The outlet of the refrigerant passage 14a of the low-temperature-side heat exchanger 14 is connected to the compressor 11 by the refrigerant channel 10c. An accumulator 15 is placed on the path of the refrigerant channel 10c.

### <High-Temperature-Side Heat Medium Circuit>

The high-temperature-side heat medium circuit 20 includes the heat medium passage 12b of the above-described high-temperature-side heat exchanger 12, and a heater core 21 accommodated in a case 110 of the HVAC unit 100 and configured to heat air supplied into the vehicle cabin. The high-temperature-side heat medium circuit 20 is a circuit through which the heat medium heated by receiving heat from the refrigerant circuit 10 via the high-temperature-side heat exchanger 12 circulates. The high-temperature-side heat medium circuit 20 can be used to cause the heater core 21 to function to heat the inside of the vehicle cabin.

In the example shown in the figures, the elements of the high-temperature-side heat medium circuit 20 are connected by heat medium channels 20a, 20b, 20c. The inlet side 21a of the heater core 21 is connected to the outlet of the heat medium passage 12b of the high-temperature-side heat exchanger 12 by the heat medium channel 20a. The inlet of the heat medium passage 12b of the high-temperature-side heat exchanger 12 is connected to the four-way valve V20 by the heat medium channel 20c. The outlet side 21b of the heater core 21 is connected to the four-way valve V20 by the heat medium channel 20b. On the path of the heat medium channel 20b, a circulation pump P20 that supplies the heat medium is placed upstream of the four-way valve V20. The heat medium is pushed out by the circulation pump P20, and circulates in the high-temperature-side heat medium circuit 20. The heat medium heated by receiving heat from the refrigerant circuit 10 when passing through the heat medium passage 12b of the high-temperature-side heat exchanger 12 is supplied to the heater core 21 from the inlet side 21a thereof, and passes through the heater core 21. At this time, the heat medium dissipates heat in the heater core 21, whereby the heater core 21 functions. The heat medium discharged from the outlet side 21b after having passed through the heater core 21 flows again toward the heat medium passage 12b of the high-temperature-side heat exchanger 12.

The high-temperature-side heat medium circuit 20 connects the channel thereof to the channel of the outdoor heat exchange circuit 60 by the four-way valve V20, thereby forming a circulation path for circulating the heat medium in cooperation with the outdoor heat exchange circuit 60.

### <Low-Temperature-Side Heat Medium Circuit>

The low-temperature-side heat medium circuit 30 includes the heat medium passage 14b of the above-described low-temperature-side heat exchanger 14, a cooler core 31 accommodated in the case 110 of the HVAC unit 100 and configured to cool air supplied to the inside of the vehicle cabin, and a three-way valve V30 for switching the circuit. The low-temperature-side heat medium circuit 30 is a circuit through which the heat medium cooled by transferring heat to the refrigerant circuit 10 via the low-temperature-side heat exchanger 14 circulates. The low-temperature-side heat medium circuit 30 can be used to cause the cooler core 31 to function to cool or dehumidify the inside of the vehicle cabin.

Further, the channel of the low-temperature-side heat medium circuit 30, the channel of the battery temperature adjustment circuit 40, and the channel of the motor temperature adjustment circuit 50 can be connected to each other by the channel switching device 70. The low-temperature-side heat medium circuit 30 can also be used for temperature adjustment of a battery 41 and temperature adjustment of a motor 51 by forming the circulation path for circulating the heat medium in cooperation with the battery temperature adjustment circuit 40 and the motor temperature adjustment circuit 50. In other words, in this case, the exhaust heat of the battery 41 and the motor 51 can be used as the heat absorption source for the refrigerant circuit 10.

In the example shown in the figures, the elements of the low-temperature-side heat medium circuit 30 are connected by heat medium channels 30a, 30b, 30c, 30d, 30e, 30f. The outlet of the heat medium passage 14b of the low-temperature-side heat exchanger 14 and the three-way valve V30 are connected by the heat medium channel 30a, and the three-way valve V30 and the inlet side 31a of the cooler core 31 are connected by the heat medium channel 30b. When the three-way valve V30 connects these heat medium channels 30a, 30b, the outlet of the heat medium passage 14b of the low-temperature-side heat exchanger 14 and the inlet side 31a of the cooler core 31 are connected.

The outlet side 31b of the cooler core 31 is connected to the channel switching device 70 via the heat medium channel 30c connected thereto, a junction point, and the heat medium channel 30e downstream thereof.

The heat medium channel 30f connects the channel switching device 70 and the inlet of the heat medium passage 14b of the low-temperature-side heat exchanger 14. On the path of the heat medium channel 30f, a circulation pump P30 that supplies the heat medium is placed.

The three-way valve V30 and the junction point are connected by the heat medium channel 30d. When the cooler core 31 is disconnected by the three-way valve V30 and the outlet of the heat medium passage 14b of the low-temperature-side heat exchanger 14 and the channel switching device 70 are connected by the heat medium channels 30a, 30d, 30e, a bypass channel bypassing the cooler core 31 is formed.

The channel of the low-temperature-side heat medium circuit 30 is connected to the channel of at least any one of the battery temperature adjustment circuit 40, the motor temperature adjustment circuit 50, or the outdoor heat exchange circuit 60 by the channel switching device 70, and can form the circulation path for circulating the heat medium in cooperation with at least any one of these circuits.

The heat medium circulates in the low-temperature-side heat medium circuit 30 by the circulation pump P30 placed on the path of the heat medium channel 30f. When passing through the heat medium passage 14b of the low-temperature-side heat exchanger 14, the heat medium is cooled by discharging heat to the refrigerant circuit 10. The cooled heat medium can be supplied to the cooler core 31 from the inlet side 31a and pass through the cooler core 31. At this time, the heat medium absorbs heat in the cooler core 31, whereby the cooler core 31 can function. The heat medium discharged from the outlet side 31b after having passed through the cooler core 31 or the heat medium bypassing the cooler core 31 is directed to the heat medium passage 14b of the low-temperature-side heat exchanger 14.

### <Battery Temperature Adjustment Circuit>

The battery temperature adjustment circuit 40 includes the battery 41 as an in-vehicle heat generating device. The battery 41 is provided with the battery 41 and a battery temperature adjuster as a heat exchanger that exchanges heat with the battery 41 as a heat absorbing target. The battery temperature adjustment circuit 40 can be used to adjust the temperature of the battery 41.

Note that a configuration similar to that of the battery temperature adjustment circuit 40 can be applied not only to the battery but also to other in-vehicle device temperature adjustment circuits having in-vehicle device temperature adjusters for temperature adjustment of other in-vehicle devices requiring temperature adjustment as well.

In the example shown in the figures, the elements of the battery temperature adjustment circuit 40 are connected by heat medium channels 40a, 40b. The inlet side 41a of the battery 41 is connected to the channel switching device 70 by the heat medium channel 40a. The outlet side 41b of the battery 41 is connected to the channel switching device 70 by the heat medium channel 40b.

The battery temperature adjustment circuit 40 can form a circulation path for independently circulating the heat medium by the channel switching device 70. The channel of the battery temperature adjustment circuit 40 is connected to the channel of at least any one of the low-temperature-side heat medium circuit 30, the motor temperature adjustment circuit 50, or the outdoor heat exchange circuit 60 by the channel switching device 70, and can form the circulation path for circulating the heat medium in cooperation with at least any one of these circuits.

On the path of the heat medium channel 40a, a circulation pump P40 and a heat medium heating device 42 are placed in this order from the upstream side. Even in a case where the battery temperature adjustment circuit 40 forms the circulation path independent of other circuits, or even in a case where no circulation pump is placed in a partner circuit that cooperatively forms the circulation path, the heat medium can be circulated by the circulation pump P40, and the temperature of the battery 41 can be adjusted.

### <Motor Temperature Adjustment Circuit>

The motor temperature adjustment circuit 50 includes the motor 51 as an in-vehicle heat generating device. The motor 51 is provided with the motor 51 and a motor temperature adjuster as a heat exchanger that exchanges heat with the motor 51 as a heat absorbing target. The motor temperature adjustment circuit 50 can be used to circulate the heat medium to adjust the temperature of the motor 51. In addition, the thermal management system 1 can use, as a heat source, the motor 51 constantly generating heat during traveling or the like via the motor temperature adjustment circuit 50.

In the example shown in the figures, the elements of the motor temperature adjustment circuit 50 are connected by heat medium channels 50a, 50b. The inlet side 51a of the motor 51 is connected to the channel switching device 70 by the heat medium channel 50a. The outlet side 51b of the motor 51 is connected to the channel switching device 70 by the heat medium channel 50b.

The channel of the motor temperature adjustment circuit 50 is connected to the channel of at least any one of the low-temperature-side heat medium circuit 30, the battery temperature adjustment circuit 40, or the outdoor heat exchange circuit 60 by the channel switching device 70, and can form the circulation path for circulating the heat medium in cooperation with at least any one of these circuits.

### <Outdoor Heat Exchange Circuit>

The outdoor heat exchange circuit 60 includes a radiator 61 as a heat exchanger that exchanges heat with outside air as a heat absorbing target, a proportional control three-way valve V60 as a flow rate adjustment device that divides the heat medium having passed through the radiator 61 and adjusts the amount of heat medium to be divided, and a three-way valve V61 for switching the circuit. The outdoor heat exchange circuit 60 can be used to circulate the heat medium to exchange heat between the heat medium and the outside air.

In the example shown in the figures, the elements of the outdoor heat exchange circuit 60 are connected by heat medium channels 60a, 60b, 60c, 60d, 60e, 60f, 60g, 60h. The inlet side 61a of the radiator 61 is connected to the four-way valve V20 by the heat medium channel 60a.

When the four-way valve V20 connects the heat medium channels 60a, 20b, the inlet side 61a of the radiator 61 is connected to the outlet side 21b of the heater core 21. The outlet side 61b of the radiator 61 is connected to the proportional control three-way valve V60 by the heat medium channel 60b.

The proportional control three-way valve V60 is connected to the four-way valve V20 via the heat medium channel 60c, the junction point, and the heat medium channel 60d downstream thereof. The proportional control three-way valve V60 is connected to the channel switching device 70 via the heat medium channel 60e.

The three-way valve V61 and the channel switching device 70 are connected by the heat medium channel 60f. Moreover, the three-way valve V61 and the heat medium channel 20b are connected by the heat medium channel 60g. When the three-way valve V61 connects these heat medium channels 60f, 60g, the channel switching device 70 is connected to the inlet side 61a of the radiator 61 via the heat medium channels 60f, 60g, the junction point, and the heat medium channels 20b, 60a downstream thereof.

Moreover, the three-way valve V61 and the heat medium channel 60c are connected by the heat medium channel 60h. When the three-way valve V61 disconnects the connection to the heat medium channel 60c and connects the heat medium channels 60e, 60f, a bypass channel bypassing the heat medium passage 12b of the high-temperature-side heat exchanger 12 is formed.

The outdoor heat exchange circuit 60 can be disconnected from and independent of other circuits by the channel switching device 70. The channel of the outdoor heat exchange circuit 60 is connected to the channel of at least any one of the low-temperature-side heat medium circuit 30, the battery temperature adjustment circuit 40, or the motor temperature adjustment circuit 50 by the channel switching device 70, and can form the circulation path for circulating the heat medium in cooperation with at least any one of these circuits.

### <HVAC Unit>

As described above, the heater core 21 of the high-temperature-side heat medium circuit 20 and the cooler core 31 of the low-temperature-side heat medium circuit 30 are accommodated in the case 110 of the HVAC unit 100. The case 110 forms an outer shell of the HVAC unit 100, and forms an air flow passage 120 therein.

Further, the HVAC unit 100 has an intake unit 130. The intake unit 130 closes either an outside air suction port for introducing air outside the vehicle cabin or an inside air suction port for introducing air inside the vehicle cabin, and switches the air introduced into the case 110 to either the air outside the vehicle cabin (outside air introduction) or the air inside the vehicle cabin (inside air circulation). Further, the HVAC unit 100 further has a blower 140 placed adjacent to the intake unit 130 such that the air introduced into case 110 is fed to the air flow passage 120.

The cooler core 31 is placed upstream of the air flow passage 120. A heater core passage 121 and a bypass passage 122 are formed in parallel downstream of the air flow passage 120. The heater core 21 is provided on the heater core passage 121. Thus, when the air introduced into the case 110 is guided to the heater core passage 121, the air is ventilated to the cooler core 31 and then to the heater core 21. On the other hand, when the air introduced into the case 110 is guided to the bypass passage 122, the air bypasses the heater core 21 after having been ventilated to the cooler core 31. A ratio between the air passing through the heater core passage 121 and the air passing through the bypass passage 122 is adjusted by an air mix damper 150.

### Operation of System

A specific operation of the thermal management system 1 according to the present embodiment will be described with reference to FIG. 1.

### <Cooling Operation>

FIG. 1 shows the state of the thermal management system 1 when an outside air temperature is high. At this time, the inside of the vehicle cabin is cooled.

The low-temperature-side heat medium circuit 30 through which the heat medium having exchanged heat in the low-temperature-side heat exchanger 14 flows is set as follows. That is, the channel switching device 70 disconnects the low-temperature-side heat medium circuit 30 from the battery temperature adjustment circuit 40, the motor temperature adjustment circuit 50, and the outdoor heat exchange circuit 60, thereby forming a circulation path in which the low-temperature-side heat medium circuit 30 independently circulates the heat medium. Moreover, the three-way valve V30 forms the heat medium channels 30a, 30b, 30c, 30e such that the heat medium cooled by the heat exchange in the low-temperature-side heat exchanger 14 flows through the cooler core 31. As a result, the heat medium circulates between the low-temperature-side heat exchanger 14 and the cooler core 31, and the inside of the vehicle cabin is cooled by the heat medium having dissipated heat in the low-temperature-side heat exchanger 14.

Note that at this time, the air mix damper 150 closes the heater core passage 121, the inside of the vehicle cabin is not heated, the air cooled by the cooler core 31 passes through the bypass passage 122, and the inside of the vehicle cabin is cooled.

The high-temperature-side heat medium circuit 20 in which the heat exchange is performed in the high-temperature-side heat exchanger 12 is set as follows. That is, the four-way valve V20 connects the high-temperature-side heat medium circuit 20 and the outdoor heat exchange circuit 60, and forms a circulation path through which the outdoor heat exchange circuit 60 and the high-temperature-side heat medium circuit 20 circulate the heat medium in cooperation with each other.

The proportional control three-way valve V60 forms the heat medium channels 60b, 60c such that the heat medium heated by the heat exchange in the high-temperature-side heat exchanger 12 passes through the radiator 61. Accordingly, the heat medium channels 20c, 20a, 20b and the heat medium channels 60a, 60b, 60c, 60d are connected, and the heat medium circulates through these circulation paths. As a result, the heat medium circulating through the high-temperature-side heat medium circuit 20 circulates via the outdoor heat exchange circuit 60. When the circulation pump P20 circulates the heat medium in the outdoor heat exchange circuit 60, the heat medium in the high-temperature-side heat medium circuit 20 also circulates. As a result, the exhaust heat of the high-temperature-side heat exchanger 12 is dissipated to the outside air via the radiator 61. Then, the refrigerant circuit 10 is operated by the heat medium having dissipated heat to the outside air in the radiator 61, and air-conditioning of the inside of the vehicle cabin is performed as cooling.

The motor temperature adjustment circuit 50 passing through the motor 51 is set as follows. That is, the channel switching device 70 connects the channels of the outdoor heat exchange circuit 60 and the motor temperature adjustment circuit 50 to each other, and forms a circulation path in which the outdoor heat exchange circuit 60 and the motor temperature adjustment circuit 50 circulate the heat medium in cooperation with each other.

The proportional control three-way valve V60 forms the heat medium channels 60b, 60e such that the heat medium having passed through the radiator 61 flows to the motor 51. The three-way valve V61 forms the heat medium channels 60f, 60g such that the heat medium heated by the heat exchange in the motor 51 passes through the radiator 61.

Accordingly, the heat medium channels 50a, 50b, the heat medium channels 60a, 60b, 60e, 60f, 60g, and the heat medium channel 20b are connected, and the heat medium circulates through these circulation paths. As a result, the heat medium circulating through the motor temperature adjustment circuit 50 circulates via the outdoor heat exchange circuit 60. When the circulation pump P20 circulates the heat medium in the outdoor heat exchange circuit 60, the heat medium in the motor temperature adjustment circuit 50 also circulates. By circulating the heat medium in this manner, as a result, the exhaust heat of the motor 51 is dissipated to the outside air via the radiator 61. Then, the motor 51 is cooled.

The proportional control valve V60 adjusts the amount of heat medium flowing from the heat medium channel 60b to the heat medium channel 60d and the amount of heat medium flowing from the heat medium channel 60b to the heat medium channel 60c according to the temperature detected by the motor 51 or the inverter included in the motor 51. That is, the proportional control valve V60 adjusts the amount of heat medium flowing from the outdoor heat exchange circuit 60 to the high-temperature-side heat medium circuit 20 and the amount of heat medium flowing from the outdoor heat exchange circuit 60 to the motor temperature adjustment circuit 50.

The proportional control valve V60 increases the flow rate of the heat medium to the heat medium channel 60c until the temperature on the motor 51 side approaches the upper limit temperature (for example, when the upper limit temperature of the motor 51 is 80 degrees and the upper limit temperature of the inverter is 60 degrees, the upper limit temperature is set to 60 degrees), and increases the flow rate of the heat medium to the heat medium channel 60d when the temperature on the motor 51 side approaches the upper limit temperature.

As a result, until the temperature on the motor 51 side approaches the upper limit temperature, a heat absorption efficiency in the high-temperature-side heat exchanger 12 is increased to decrease a condensation temperature, thereby increasing a cooling efficiency, and when the temperature on the motor 51 side approaches the upper limit temperature, the motor 51 can be cooled. Thus, it is possible to efficiently cool the inside of the vehicle cabin and cool the motor 51 according to the situation. In addition, since the heat medium having passed through the radiator 61 is divided into the high-temperature-side heat medium circuit 20 and the motor temperature adjustment circuit 50, it is possible to prevent the heat medium having passed through one of these circuits from passing through the other one. Thus, it is possible to prevent inconveniences such as a decrease in the cooling efficiency due to the flow of the high-temperature heat medium to the high-temperature-side heat exchanger 12 and a failure in sufficient cooling of the motor 51 due to the flow of the high-temperature heat medium to the motor 51.

Further, in the present embodiment, since the circulation pump P20 that circulates the heat medium of the outdoor heat exchange circuit 60 to circulate the heat medium flowing through the high-temperature-side heat medium circuit 20 and the motor temperature adjustment circuit 50 when the cooling operation is performed in the vehicle cabin is provided, it is not necessary to provide the circulation pump in each of the high-temperature-side heat medium circuit 20 and the motor temperature adjustment circuit 50 when the cooling operation is performed, and it is possible to suppress an increase in the number of circulation pumps to be placed.

### <Heating Operation>

In the heating operation, the high-temperature-side heat medium circuit 20 in which the heat exchange is performed in the high-temperature-side heat exchanger 12 is set as follows. The four-way valve V20 disconnects the high-temperature-side heat medium circuit 20 and the outdoor heat exchange circuit 60, and forms a circulation path through which the high-temperature-side heat medium circuit 20 independently circulates the heat medium. That is, the four-way valve V20 connects the heat medium channel 20b and the heat medium channel 20c such that the heat medium pushed out by the circulation pump P20 flows to the high-temperature-side heat exchanger 12 without passing through the radiator 61. As a result, in the high-temperature-side heat medium circuit 20 during the heating operation, a circulation path is formed by the heat medium channels 20a, 20b, 20c, and the heat medium circulates through such a circulation path. In this circulation path, the circulation pump P20 is used for circulating the heat medium. Then, the heat medium heated by the heat exchange in the high-temperature-side heat exchanger 12 flows to the heater core 21, and the inside of the vehicle cabin is heated by the heat of the heat medium absorbed in the high-temperature-side heat exchanger 12. Note that at this time, the air mix damper 150 opens the heater core passage 121, so that the inside of the vehicle cabin is heated.

The low-temperature-side heat medium circuit 30 through which the heat medium having exchanged heat in the low-temperature-side heat exchanger 14 flows is set as follows. That is, the channel switching device 70 connects the low-temperature-side heat medium circuit 30, the motor temperature adjustment circuit 50, and the outdoor heat exchange circuit 60, and forms a circulation path in which the low-temperature-side heat medium circuit 30, the motor temperature adjustment circuit 50, and the outdoor heat exchange circuit 60 circulate the heat medium in cooperation with each other. In this circulation path, the circulation pump P30 provided in the low-temperature-side heat medium circuit 30 is used for circulating the heat medium. As described above, the refrigerant circuit 10 operates using the heat of the heat medium absorbed from the outside air in the motor 51 and the radiator 61 as a heat absorption source.

As described above, since the circulation pump P30 is used for circulating the heat medium in the low-temperature-side heat medium circuit 30, the motor temperature adjustment circuit 50, and the outdoor heat exchange circuit 60 when the heating operation is performed, it is not necessary to use the circulation pump P20 for circulation in the outdoor heat exchange circuit 60 and the motor temperature adjustment circuit 50. Thus, since the circulation pump P20 can be used for circulating the heat medium in the high-temperature-side heat medium circuit 20 during the heating operation, it is not necessary to separately provide a circulation pump for circulating the heat medium in the high-temperature-side heat medium circuit 20, so that an increase in the number of circulation pumps can be suppressed.

### System

According to the thermal management system 1 according to the present embodiment, when the cooling operation is performed, the heat medium circulating in the high-temperature-side heat medium circuit 20 circulates via the outdoor heat exchange circuit 60, the heat medium circulating in the motor temperature adjustment circuit 50 circulates via the outdoor heat exchange circuit 60, and the amount of heat medium flowing from the outdoor heat exchange circuit 60 to the high-temperature-side heat medium circuit 20 and the amount of heat medium flowing from the outdoor heat exchange circuit 60 to the motor temperature adjustment circuit 50 are adjusted by the proportional control three-way valve V60. Thus, it is possible to efficiently cool the inside of the vehicle cabin and the motor 51 according to the situation. In addition, since the heat medium having passed through the radiator 61 is divided into the high-temperature-side heat medium circuit 20 and the motor temperature adjustment circuit 50, it is possible to prevent the heat medium having passed through one of these circuits from passing through the other one. Thus, it is possible to prevent inconveniences such as a decrease in the cooling efficiency due to the flow of the high-temperature heat medium to the high-temperature-side heat exchanger 12 and a failure in sufficient cooling of the motor 51 due to the flow of the high-temperature heat medium to the motor 51.

According to the thermal management system 1 of the present embodiment, by circulating the heat medium in the outdoor heat exchange circuit 60 using the circulation pump P20 of the high-temperature-side heat medium circuit 20, an increase in the number of circulation pumps placed can be suppressed.

According to the thermal management system 1 of the present embodiment, when the four-way valve V20 makes the high-temperature-side heat medium circuit 20 independent of the outdoor heat exchange circuit 60 during the heating operation of the inside of the vehicle cabin, the circulation pump P20 circulates the heat medium of the high-temperature-side heat medium circuit 20. Thus, it is not necessary to separately provide a circulation pump for circulating the heat medium of the high-temperature-side heat medium circuit 20, and an increase in the number of circulation pumps can be suppressed.

Note that in the first embodiment, the example where the heat medium distributed by the proportional control three-way valve V60 is caused to flow to the motor 51 as the heat generating device has been described. However, the channel switching device 70 may connect the battery temperature adjustment circuit 40 and the outdoor heat exchange circuit 60 to form a circulation path in which the battery temperature adjustment circuit 40 and the outdoor heat exchange circuit 60 circulate the heat medium in cooperation with each other, so that the heat medium distributed by the proportional control three-way valve V60 may be caused to flow to the battery 41 as the heat generating device.

The thermal management system 1 of the first embodiment can achieve the following effects.

(1) When the cooling operation is performed, the heat medium circulating in the high-temperature-side heat medium circuit 20 circulates via the outdoor heat exchange circuit 60, the heat medium circulating in the motor temperature adjustment circuit 50 circulates via the outdoor heat exchange circuit 60, and the amount of heat medium flowing from the outdoor heat exchange circuit 60 to the high-temperature-side heat medium circuit 20 and the amount of heat medium flowing from the outdoor heat exchange circuit 60 to the motor temperature adjustment circuit 50 are adjusted by the proportional control three-way valve V60.

As a result, until the temperature on the motor 51 side approaches the upper limit temperature, a heat absorption efficiency in the high-temperature-side heat exchanger 12 is increased to decrease a condensation temperature, thereby increasing a cooling efficiency, and when the temperature on the motor 51 side approaches the upper limit temperature, the motor 51 can be cooled. Thus, it is possible to efficiently cool the inside of the vehicle cabin and cool the motor 51 according to the situation. In addition, since the heat medium having passed through the radiator 61 is divided into the high-temperature-side heat medium circuit 20 and the motor temperature adjustment circuit 50, it is possible to prevent the heat medium having passed through one of these circuits from passing through the other one. Thus, it is possible to prevent inconveniences such as a decrease in the cooling efficiency due to the flow of the high-temperature heat medium to the high-temperature-side heat exchanger 12 and a failure in sufficient cooling of the motor 51 due to the flow of the high-temperature heat medium to the motor 51.

(2) The thermal management system 1 includes the circulation pump P20 that circulates the heat medium in the outdoor heat exchange circuit 60 to circulate the heat medium flowing through the high-temperature-side heat medium circuit 20 and the motor temperature adjustment circuit 50 when the cooling operation is performed in the vehicle cabin.

With this configuration, since the heat medium can circulate in the high-temperature-side heat medium circuit 20 and the motor temperature adjustment circuit 50 by the circulation pump P20, it is not necessary to provide a circulation pump in each of the high-temperature-side heat medium circuit 20 and the motor temperature adjustment circuit 50 when the cooling operation is performed, and an increase in the number of circulation pumps placed can be suppressed.

(3) Since the circulation pump P30 is used for circulating the heat medium in the low-temperature-side heat medium circuit 30, the motor temperature adjustment circuit 50, and the outdoor heat exchange circuit 60 when the heating operation is performed, it is not necessary to use the circulation pump P20 for circulation in the outdoor heat exchange circuit 60 and the motor temperature adjustment circuit 50. During the heating operation in the vehicle cabin, the four-way valve V20 makes the high-temperature-side heat medium circuit 20 independent of the outdoor heat exchange circuit 60.

Thus, since the circulation pump P20 can be used for circulating the heat medium in the high-temperature-side heat medium circuit 20 during the heating operation, it is not necessary to separately provide a circulation pump for circulating the heat medium in the high-temperature-side heat medium circuit 20, so that an increase in the number of circulation pumps can be suppressed.

### Second Embodiment

A second embodiment will be described.

### Configuration of System

### <Outline of System>

One embodiment as the second embodiment will be described with reference to the drawings. The present embodiment relates to a thermal management system having a refrigerant circuit and a heat medium circuit. A thermal management system of the present embodiment is mounted on an electric vehicle, and is configured to easily control a dehumidification amount and a blower air temperature to the inside of the vehicle cabin during a dehumidification heating operation.

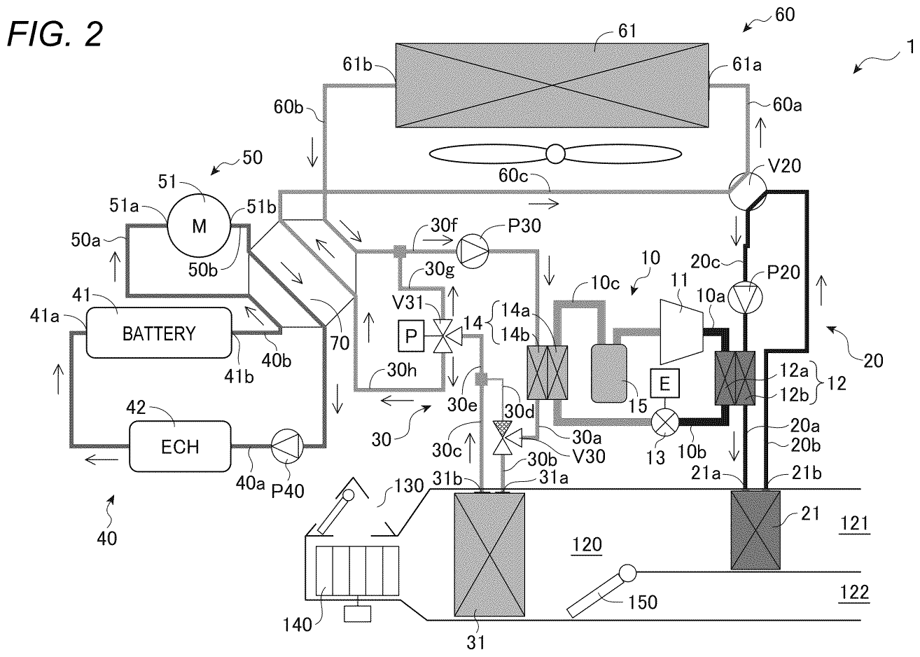

FIGS. 2 to 4 are schematic diagrams for describing a configuration example of a thermal management system 1 according to the present embodiment. The thermal management system 1 is configured such that a circuit is switched according to various operations. Each of FIGS. 2 to 4 shows a circuit configuration during the dehumidification heating operation of the various operations. Note that an arrow in the figure indicates a direction in which a heat medium flows.

The thermal management system 1 includes a refrigerant circuit 10 configured to circulate refrigerant. The refrigerant is not limited thereto, and for example, hydrofluoroolefin or the like may be used. Further, the thermal management system 1 includes a high-temperature-side heat medium circuit 20, a low-temperature-side heat medium circuit 30, a battery temperature adjustment circuit 40, a motor temperature adjustment circuit 50, and an outdoor heat exchange circuit 60, which are configured to circulate a heat medium as fluid such as a coolant, for example. Among these circuits, the low-temperature-side heat medium circuit 30, the battery temperature adjustment circuit 40, the motor temperature adjustment circuit 50, and the outdoor heat exchange circuit 60 are connected to a channel switching device 70 such as an eight-way valve. The channel switching device 70 can couple these channels to each other to form a circulation path in which these circuits cooperate to circulate the heat medium, or disconnect one or more circuits from other circuits to independently operate these circuits. The high-temperature-side heat medium circuit 20 and the outdoor heat exchange circuit 60 are connected to a channel switching device such as a four-way valve V20 that connects or disconnects the channels to or from each other. The four-way valve V20 can form the circulation path in which the high-temperature-side heat medium circuit 20 and the outdoor heat exchange circuit 60 cooperate to circulate the heat medium, or can disconnect these circuits from each other.

Further, the thermal management system 1 includes a heating, ventilation, and air conditioning (HVAC) unit 100. In addition, the thermal management system 1 includes various sensors (not shown) and a control device that controls operation of each unit of the thermal management system 1. The operation of the thermal management system 1 is controlled based on detection values of the various sensors, various requests, and the like.

### <Refrigerant Circuit>

The refrigerant circuit 10 includes a compressor 11 that compresses gaseous refrigerant into high-temperature high-pressure refrigerant and then discharge the high-temperature high-pressure refrigerant, a high-temperature-side heat exchanger 12 that condenses the compressed gaseous refrigerant to dissipate heat, a decompression device 13, such as an expansion valve, that expands liquid refrigerant into low-pressure refrigerant, and a low-temperature-side heat exchanger 14 that evaporates the low-temperature low-pressure liquid refrigerant to absorb heat. The refrigerant circuit 10 is configured to function as a heat pump that circulates the refrigerant and repeats compression, condensation, expansion, and evaporation.

In the high-temperature-side heat exchanger 12, the refrigerant exchanges heat with the heat medium circulating in the high-temperature-side heat medium circuit 20. Moreover, in the low-temperature-side heat exchanger 14, the refrigerant exchanges heat with the heat medium circulating in the low-temperature-side heat medium circuit 30.

In the example shown in the figures, the high-temperature-side heat exchanger 12 includes a refrigerant passage 12a through which the refrigerant circulating in the refrigerant circuit 10 passes, and a heat medium passage 12b through which the heat medium circulating in the high-temperature-side heat medium circuit 20 passes. The low-temperature-side heat exchanger 14 includes a refrigerant passage 14a through which the refrigerant circulating in the refrigerant circuit 10 passes, and a heat medium passage 14b through which the heat medium circulating in the low-temperature-side heat medium circuit 30 passes.

The elements of the refrigerant circuit 10 are connected by refrigerant channels 10a, 10b, 10c. The compressor 11 is connected to the inlet of the refrigerant passage 12a of the high-temperature-side heat exchanger 12 by the refrigerant channel 10a. The outlet of the refrigerant passage 12a of the high-temperature-side heat exchanger 12 is connected to the inlet of the refrigerant passage 14a of the low-temperature-side heat exchanger 14 by the refrigerant channel 10b, and the decompression device 13 such as an expansion valve is placed on the path of the refrigerant channel 10b. The outlet of the refrigerant passage 14a of the low-temperature-side heat exchanger 14 is connected to the compressor 11 by the refrigerant channel 10c. An accumulator 15 is placed on the path of the refrigerant channel 10c.

### <High-Temperature-Side Heat Medium Circuit>

The high-temperature-side heat medium circuit 20 includes the heat medium passage 12b of the above-described high-temperature-side heat exchanger 12, and a heater core 21 accommodated in a case 110 of the HVAC unit 100 and configured to heat air supplied into the vehicle cabin. The high-temperature-side heat medium circuit 20 is a circuit through which the heat medium heated by receiving heat from the refrigerant circuit 10 via the high-temperature-side heat exchanger 12 circulates. The high-temperature-side heat medium circuit 20 can be used to cause the heater core 21 to function to heat the inside of the vehicle cabin.

In the example shown in the figures, the elements of the high-temperature-side heat medium circuit 20 are connected by heat medium channels 20a, 20b, 20c. The inlet side 21a of the heater core 21 is connected to the outlet of the heat medium passage 12b of the high-temperature-side heat exchanger 12 by the heat medium channel 20a. The inlet of the heat medium passage 12b of the high-temperature-side heat exchanger 12 is connected to the four-way valve V20 by the heat medium channel 20c. The outlet side 21b of the heater core 21 is connected to the four-way valve V20 by the heat medium channel 20b. On the path of the heat medium channel 20c, a circulation pump P20 that supplies the heat medium is placed. The heat medium is pushed out by the circulation pump P20, and circulates in the high-temperature-side heat medium circuit 20. The heat medium heated by receiving heat from the refrigerant circuit 10 when passing through the heat medium passage 12b of the high-temperature-side heat exchanger 12 is supplied to the heater core 21 from the inlet side 21a thereof, and passes through the heater core 21. At this time, the heat medium dissipates heat in the heater core 21, whereby the heater core 21 functions. The heat medium discharged from the outlet side 21b after having passed through the heater core 21 flows again toward the heat medium passage 12b of the high-temperature-side heat exchanger 12.

### <Low-Temperature-Side Heat Medium Circuit>

The low-temperature-side heat medium circuit 30 includes the heat medium passage 14b of the above-described low-temperature-side heat exchanger 14, a cooler core 31 accommodated in the case 110 of the HVAC unit 100 and configured to cool air supplied to the inside of the vehicle cabin, a three-way valve V30 for switching the circuit, and a proportional control three-way valve V31 as a flow divider capable of dividing the heat medium flowing in the circuit. The low-temperature-side heat medium circuit 30 is a circuit through which the heat medium cooled by transferring heat to the refrigerant circuit 10 via the low-temperature-side heat exchanger 14 circulates. The low-temperature-side heat medium circuit 30 can be used to cause the cooler core 31 to function to cool or dehumidify the inside of the vehicle cabin.

Further, the channel of the low-temperature-side heat medium circuit 30, the channel of the battery temperature adjustment circuit 40, and the channel of the motor temperature adjustment circuit 50 can be connected to each other by the channel switching device 70. The low-temperature-side heat medium circuit 30 can also be used for temperature adjustment of a battery 41 and temperature adjustment of a motor 51 by forming a circulation path in which the battery temperature adjustment circuit 40 and the motor temperature adjustment circuit 50 circulate the heat medium in cooperation with each other. In other words, in this case, the exhaust heat of the battery 41 and the motor 51 can be used as the heat absorption source for the refrigerant circuit 10.

In the example shown in the figures, the elements of the low-temperature-side heat medium circuit 30 are connected by heat medium channels 30a, 30b, 30c, 30d, 30e, 30f, 30g, 30h. The outlet of the heat medium passage 14b of the low-temperature-side heat exchanger 14 and the three-way valve V30 are connected by the heat medium channel 30a, and the three-way valve V30 and the inlet side 31a of the cooler core 31 are connected by the heat medium channel 30b. When the three-way valve V30 connects these heat medium channels 30a, 30b, the outlet of the heat medium passage 14b of the low-temperature-side heat exchanger 14 and the inlet side 31a of the cooler core 31 are connected.

The outlet side 31b of the cooler core 31 is connected to the proportional control three-way valve V31 via the heat medium channel 30c connected thereto, a junction point, and the heat medium channel 30e downstream thereof. In other words, the proportional control three-way valve V31 is disposed downstream of the cooler core 31. The proportional control three-way valve V31 is connected to the channel switching device 70 via the heat medium channel 30h.

The three-way valve V30 and the junction point are connected by the heat medium channel 30d. When the cooler core 31 is disconnected by the three-way valve V30 and the outlet of the heat medium passage 14b of the low-temperature-side heat exchanger 14 and the channel switching device 70 are connected by the heat medium channels 30a, 30d, 30e, a bypass channel bypassing the cooler core 31 is formed.

The heat medium channel 30f connects the channel switching device 70 and the inlet of the heat medium passage 14b of the low-temperature-side heat exchanger 14. On the path of the heat medium channel 30f, a circulation pump P30 that supplies the heat medium is placed. The proportional control three-way valve V31 is connected to the inlet of the heat medium passage 14b of the low-temperature-side heat exchanger 14 via the heat medium channel 30g, a junction point, and the heat medium channel 30f downstream thereof.

The channel of the low-temperature-side heat medium circuit 30 is connected to the channel of at least any one of the battery temperature adjustment circuit 40, the motor temperature adjustment circuit 50, or the outdoor heat exchange circuit 60 by the channel switching device 70, and can form the circulation path for circulating the heat medium in cooperation with at least any one of these circuits.

The heat medium circulates in the low-temperature-side heat medium circuit 30 by the circulation pump P30 placed on the path of the heat medium channel 30f. When passing through the heat medium passage 14b of the low-temperature-side heat exchanger 14, the heat medium is cooled by discharging heat to the refrigerant circuit 10. The cooled heat medium can be supplied to the cooler core 31 from the inlet side 31a and pass through the cooler core 31. At this time, the heat medium absorbs heat in the cooler core 31, whereby the cooler core 31 can function. The heat medium discharged from the outlet side 31b after having passed through the cooler core 31 or the heat medium having bypassed the cooler core 31 then passes through at least any one of the battery temperature adjustment circuit 40, the motor temperature adjustment circuit 50, or the outdoor heat exchange circuit 60 connected via the channel switching device 70, and flows again toward the heat medium passage 14b of the low-temperature-side heat exchanger 14.

### <Battery Temperature Adjustment Circuit>

The battery temperature adjustment circuit 40 includes the heat medium passage 14b of the above-described low-temperature-side heat exchanger 14 and the battery 41 as an in-vehicle heat generating device. The battery 41 is provided with a battery temperature adjuster for adjusting the temperature of the battery 41 as a heat exchanger that exchanges heat with the battery 41 as a heat absorbing target. The battery temperature adjustment circuit 40 can be used to adjust the temperature of the battery 41.

Note that a configuration similar to that of the battery temperature adjustment circuit 40 can be applied not only to the battery but also to other in-vehicle device temperature adjustment circuits having in-vehicle device temperature adjusters for temperature adjustment of other in-vehicle devices requiring temperature adjustment as well.

In the example shown in the figures, the elements of the battery temperature adjustment circuit 40 are connected by heat medium channels 40a, 40b. The inlet side 41a of the battery 41 is connected to the channel switching device 70 by the heat medium channel 40a. The outlet side 41b of the battery 41 is connected to the channel switching device 70 by the heat medium channel 40b.

The battery temperature adjustment circuit 40 can form a circulation path for independently circulating the heat medium by the channel switching device 70. The channel of the battery temperature adjustment circuit 40 is connected to the channel of at least any one of the low-temperature-side heat medium circuit 30, the motor temperature adjustment circuit 50, or the outdoor heat exchange circuit 60 by the channel switching device 70, and can form the circulation path for circulating the heat medium in cooperation with at least any one of these circuits.

On the path of the heat medium channel 40a, a circulation pump P40 and a heat medium heating device 42 are placed in this order from the upstream side. Even in a case where the battery temperature adjustment circuit 40 forms the circulation path independent of other circuits, or even in a case where no circulation pump is placed in a partner circuit that cooperatively forms the circulation path, the heat medium can be circulated by the circulation pump P40, and the temperature of the battery 41 can be adjusted.

### <Motor Temperature Adjustment Circuit>

The motor temperature adjustment circuit 50 includes the motor 51 as an in-vehicle heat generating device. The motor 51 is provided with a motor temperature adjuster for adjusting the temperature of the motor 51 as a heat exchanger that exchanges heat with the motor 51 as a heat absorbing target. The motor temperature adjustment circuit 50 can be used to circulate the heat medium to adjust the temperature of the motor 51. In addition, the thermal management system 1 can use, as a heat source, the motor 51 constantly generating heat during traveling or the like via the motor temperature adjustment circuit 50.

In the example shown in the figures, the elements of the motor temperature adjustment circuit 50 are connected by heat medium channels 50a, 50b. The inlet side 51a of the motor 51 is connected to the channel switching device 70 by the heat medium channel 50a. The outlet side 51b of the motor 51 is connected to the channel switching device 70 by the heat medium channel 50b. The channel of the motor temperature adjustment circuit 50 is connected to the channel of at least any one of the low-temperature-side heat medium circuit 30, the battery temperature adjustment circuit 40, or the outdoor heat exchange circuit 60 by the channel switching device 70, and can form the circulation path for circulating the heat medium in cooperation with at least any one of these circuits.

### <Outdoor Heat Exchange Circuit>

The outdoor heat exchange circuit 60 includes a radiator 61 as a heat exchanger that exchanges heat with outside air as a heat absorbing target. The outdoor heat exchange circuit 60 can be used to circulate the heat medium to exchange heat between the heat medium and the outside air.

In the example shown in the figures, the elements of the outdoor heat exchange circuit 60 are connected by heat medium channels 60a, 60b, 60c. The inlet side 61a of the radiator 61 is connected to the four-way valve V20 by the heat medium channel 60a. The channel switching device 70 and the four-way valve V20 are connected by the heat medium channel 60c. When the four-way valve V20 connects these two heat medium channels 60a, 60c, the inlet side 61a of the radiator 61 is connected to the channel switching device 70. The outlet side 61b of the radiator 61 is connected to the channel switching device 70 by the heat medium channel 60b.

The outdoor heat exchange circuit 60 can be disconnected from and independent of other circuits by the channel switching device 70. The channel of the outdoor heat exchange circuit 60 is connected to the channel of at least any one of the low-temperature-side heat medium circuit 30, the battery temperature adjustment circuit 40, or the motor temperature adjustment circuit 50 by the channel switching device 70, and can form the circulation path for circulating the heat medium in cooperation with at least any one of these circuits.

### <HVAC Unit>

As described above, the heater core 21 of the high-temperature-side heat medium circuit 20 and the cooler core 31 of the low-temperature-side heat medium circuit 30 are accommodated in the case 110 of the HVAC unit 100. The case 110 forms an outer shell of the HVAC unit 100, and forms an air flow passage 120 therein.

Further, the HVAC unit 100 has an intake unit 130. The intake unit 130 closes either an outside air suction port for introducing air outside the vehicle cabin or an inside air suction port for introducing air inside the vehicle cabin, and switches the air introduced into the case 110 to either the air outside the vehicle cabin (outside air introduction) or the air inside the vehicle cabin (inside air circulation). Further, the HVAC unit 100 further has a blower 140 placed adjacent to the intake unit 130 such that the air introduced into case 110 is fed to the air flow passage 120.

The cooler core 31 is placed upstream of the air flow passage 120. A heater core passage 121 and a bypass passage 122 are formed in parallel downstream of the air flow passage 120. The heater core 21 is provided on the heater core passage 121. Thus, when the air introduced into the case 110 is guided to the heater core passage 121, the air is ventilated to the cooler core 31 and then to the heater core 21. On the other hand, when the air introduced into the case 110 is guided to the bypass passage 122, the air bypasses the heater core 21 after having been ventilated to the cooler core 31. A ratio between the air passing through the heater core passage 121 and the air passing through the bypass passage 122 is adjusted by an air mix damper 150.

### Operation of System

A specific operation of the thermal management system 1 according to the present embodiment will be described with reference to each figure.

### <Dehumidification Heating Operation (Startup/Below Appropriate Battery Temperature Range)>

FIG. 2 shows the state of the thermal management system 1 at the time of startup in the dehumidification heating operation.

The high-temperature-side heat medium circuit 20 through which the heat medium having exchanged heat in the high-temperature-side heat exchanger 12 flows is set as follows. That is, the four-way valve V20 connects the heat medium channels 20b, 20c such that the heat medium heated by the heat exchange in the high-temperature-side heat exchanger 12 circulates through the high-temperature-side heat medium circuit 20 disconnected from the outdoor heat exchange circuit 60 and flows through the heater core 21. As a result, the inside of the vehicle cabin is heated by the heat of the heat medium absorbed in the high-temperature-side heat exchanger 12.

The low-temperature-side heat medium circuit 30 through which the heat medium having exchanged heat in the low-temperature-side heat exchanger 14 flows is set as follows. That is, the three-way valve V30 forms the heat medium channels 30a, 30b such that the heat medium cooled by the heat exchange in the low-temperature-side heat exchanger 14 passes through the cooler core 31.

The channel switching device 70 connects the channels of the low-temperature-side heat medium circuit 30 and the outdoor heat exchange circuit 60 to each other, and forms the circulation path in which the low-temperature-side heat medium circuit 30 and the outdoor heat exchange circuit 60 cooperate to circulate the heat medium. The proportional control three-way valve V31 forms the heat medium channels 30c, 30e, 30h such that the heat medium having flowed through the cooler core 31 passes through the radiator 61.

That is, the heat medium channels 30a, 30b, 30c, 30e, 30h, 30f of the low-temperature-side heat medium circuit 30 and the heat medium channels 60c, 60a, 60b passing through the radiator 61 are connected, and the heat medium circulates through these circulation paths. As a result, the heat medium flowing from the proportional control three-way valve V31 to the heat medium channel 30h circulates via the radiator 61. Then, the heat medium having exchanged heat in the low-temperature-side heat exchanger 14 passes through the radiator 61, and exchanges heat with the outside air. As described above, the refrigerant circuit 10 operates using the heat of the heat medium absorbed from the outside air in the radiator 61 as a heat absorption source.

The proportional control three-way valve V31 forms the heat medium channels 30c, 30e, 30g such that the heat medium having flowed through the cooler core 31 does not pass through the radiator 61. That is, the heat medium circulates in a circulation path including the heat medium channels 30a, 30b, 30c, 30e, 30g, 30f of the low-temperature-side heat medium circuit 30. As a result, the heat medium flowing from the proportional control three-way valve V31 to the heat medium channel 30g circulates without passing through the radiator 61. Then, the heat medium subjected to heat exchange in the low-temperature-side heat exchanger 14 flows directly to the low-temperature-side heat exchanger 14.

Then, the heat medium divided by the proportional control three-way valve V31 is joined in the heat medium channel 30f and flows to the low-temperature-side heat exchanger 14, and is cooled by exchanging heat in the low-temperature-side heat exchanger 14. When the heat medium cooled by the heat exchange in the low-temperature-side heat exchanger 14 flows to the cooler core 31, the cooler core 31 is cooled. Thus, moisture in air blown from the blower 140 is condensed and dehumidified by the cooler core 31. At this time, the air mix damper 150 opens the heater core passage 121. Thus, the air dehumidified by the cooler core 31 is ventilated to the heater core 21. The air ventilated to the heater core 21 is heated and blown into the vehicle cabin. As a result, the inside of the vehicle cabin is dehumidified and heated.

As described above, the proportional control three-way valve V31 can divide the heat medium having flowed through the cooler core 31 into the heat medium channel 30g as a first channel through which the heat medium having flowed through the cooler core 31 flows to the low-temperature-side heat exchanger 14 without passing through the radiator 61, and the heat medium channel 30h as a second channel through which the heat medium having flowed through the cooler core 31 flows to the low-temperature-side heat exchanger 14 via the radiator 61.

The proportional control three-way valve V31 changes the ratio between the amount of heat medium flowing through the heat medium channel 30g and the amount of heat medium flowing through the heat medium channel 30h according to the temperature of air blown into the vehicle cabin. That is, when the temperature of air blown into the vehicle cabin is too high, the proportional control three-way valve V31 increases the flow rate of the heat medium to the heat medium channel 30g. As a result, the flow rate of the heat medium absorbing heat in the radiator 61 and flowing to the low-temperature-side heat exchanger 14 decreases, and the flow rate of the heat medium flowing to the low-temperature-side heat exchanger 14 without absorbing heat in the radiator 61 increases. Thus, the heat medium having a low temperature flows to the cooler core 31 after the heat exchange in the low-temperature-side heat exchanger 14. As a result, since the temperature of the cooler core 31 decreases, the temperature decreases while the dehumidification amount of air blown into the vehicle cabin increases.

On the other hand, when the temperature of air blown into the vehicle cabin is too low, the proportional control three-way valve V31 increases the flow rate of the heat medium to the heat medium channel 30h. As a result, the flow rate of the heat medium absorbing heat in the radiator 61 and flowing to the low-temperature-side heat exchanger 14 increases, and the flow rate of the heat medium flowing to the low-temperature-side heat exchanger 14 without absorbing heat in the radiator 61 decreases. Thus, the heat medium having a high temperature flows to the cooler core 31 after the heat exchange in the low-temperature-side heat exchanger 14. As a result, since the temperature of the cooler core 31 increases, the temperature increases while the dehumidification amount of air blown into the vehicle cabin decreases.

In either case, the flow rate of the heat medium flowing through the cooler core 31 is kept constant, but the ratio between the heat medium having absorbed heat and the heat medium having not absorbed heat is proportionally changed by the proportional control three-way valve V31. Thus, since the temperature of the heat medium flowing through the cooler core 31 also changes proportionally, a change in the blower air temperature to the inside of the vehicle cabin and a change in the dehumidification amount to the inside of the vehicle cabin when the flow division ratio of the heat medium is changed by the proportional control three-way valve V31 can be made gentle. As a result, it is possible to suppress a decrease in comfort due to the change in the blower air temperature to the inside of the vehicle cabin. In addition, since the temperature of the heat medium flowing directly from the cooler core 31 to the low-temperature-side heat exchanger 14 can be controlled proportionally by the proportional control three-way valve V31, the dehumidification amount can be easily and finely controlled.

In addition, by controlling the ratio of the heat medium divided by the proportional control three-way valve V31, the amount of heat absorbed in the radiator 61 can be controlled by adjusting the amount of heat medium flowing to the radiator 61. Thus, the dehumidification amount can be easily controlled even if a shutter for controlling the amount of air flowing into the radiator 61 is not provided.

Note that the channel switching device 70 connects the channels of the battery temperature adjustment circuit 40 and the motor temperature adjustment circuit 50 to each other, and forms the circulation path in which the battery temperature adjustment circuit 40 and the motor temperature adjustment circuit 50 cooperate to circulate the heat medium. That is, the heat medium channels 50a, 50b passing through the motor 51 and the heat medium channels 40a, 40b passing through the battery 41 are connected, and the heat medium circulates through this circulation path. As a result, the battery 41 is heated by the exhaust heat of the motor 51.

### <Dehumidification Heating Operation (Increased Battery Temperature)>

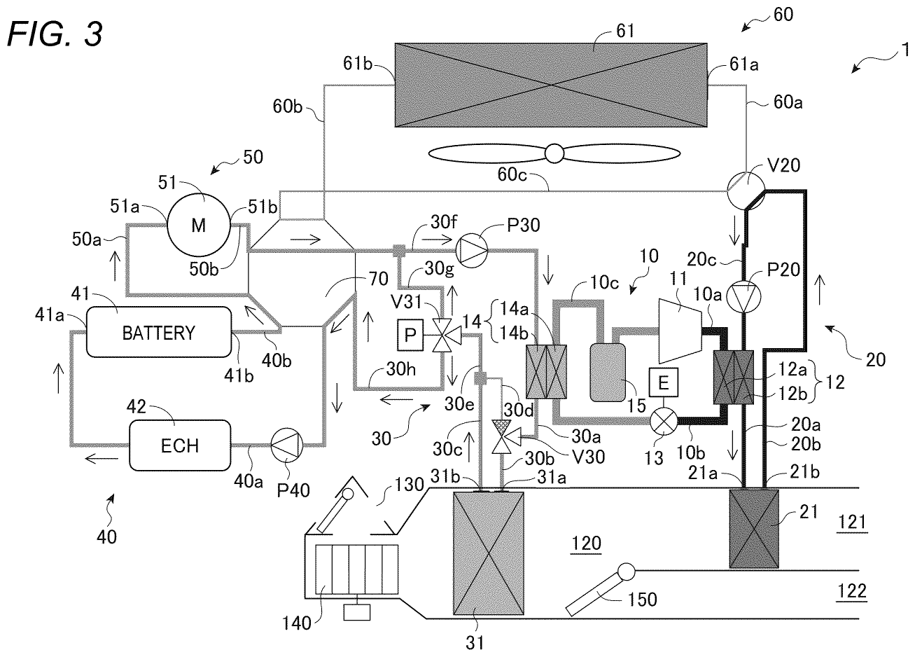

FIG. 3 shows the state of the thermal management system 1 when the temperature of the battery 41 increases and is about to exceed the upper limit of the appropriate temperature range in the dehumidification heating operation.

The high-temperature-side heat medium circuit 20 through which the heat medium having exchanged heat in the high-temperature-side heat exchanger 12 flows is set as follows. That is, the four-way valve V20 connects the heat medium channels 20b, 20c such that the heat medium heated by the heat exchange in the high-temperature-side heat exchanger 12 circulates through the high-temperature-side heat medium circuit 20 disconnected from the outdoor heat exchange circuit 60 and flows through the heater core 21. As a result, the inside of the vehicle cabin is heated by the heat of the heat medium absorbed in the high-temperature-side heat exchanger 12.

For example, in the environment where the outside air temperature is not so low as in the intermediate period, in a case where the heating operation can be performed only by the exhaust heat of the motor 51 and the battery 41, as shown in FIG. 3, the channel switching device 70 and the four-way valve V20 cause the outdoor heat exchange circuit 60 to independently form the circulation path of the heat medium.

The low-temperature-side heat medium circuit 30 through which the heat medium having exchanged heat in the low-temperature-side heat exchanger 14 flows is set as follows. That is, the three-way valve V30 forms the heat medium channels 30a, 30b such that the heat medium cooled by the heat exchange in the low-temperature-side heat exchanger 14 passes through the cooler core 31.

The channel switching device 70 connects the channels of the low-temperature-side heat medium circuit 30, the battery temperature adjustment circuit 40, and the motor temperature adjustment circuit 50 to each other, and forms the circulation path in which the low-temperature-side heat medium circuit 30, the battery temperature adjustment circuit 40, and the motor temperature adjustment circuit 50 cooperate to circulate the heat medium. The proportional control three-way valve V31 forms the heat medium channels 30c, 30e, 30h such that the heat medium having flowed through the cooler core 31 passes through the battery 41 and the motor 51.

That is, the heat medium channels 30a, 30b, 30c, 30e, 30h, 30f of the low-temperature-side heat medium circuit 30, the heat medium channels 40a, 40b passing through the battery 41, and the heat medium channels 50a, 50b passing through the motor 51 are connected, and the heat medium circulates through these circulation paths. As a result, the heat medium having flowed to the proportional control three-way valve V31 heat medium channel 30h circulates via the battery temperature adjuster and the motor temperature adjuster. Then, the heat medium subjected to heat exchange in the low-temperature-side heat exchanger 14 absorbs heat in the battery 41 and the motor 51. As described above, the refrigerant circuit 10 operates using the heat of the heat medium absorbed from the battery 41 and the motor 51 as a heat absorption source. At this time, the battery 41 and the motor 51 are cooled.

The proportional control three-way valve V31 forms the heat medium channels 30c, 30e, 30g such that the heat medium having flowed through the cooler core 31 does not pass through the battery temperature adjuster and the motor temperature adjuster. That is, the heat medium circulates in a circulation path including the heat medium channels 30a, 30b, 30c, 30e, 30g, 30f of the low-temperature-side heat medium circuit 30. As a result, the heat medium having flowed to the heat medium channel 30g from the proportional control three-way valve V31 circulates without passing through the battery temperature adjuster and the motor temperature adjuster. Then, the heat medium subjected to heat exchange in the low-temperature-side heat exchanger 14 flows directly to the low-temperature-side heat exchanger 14.

Then, the heat medium divided from the proportional control three-way valve V31 is joined in the heat medium channel 30f and flows to the low-temperature-side heat exchanger 14, and is cooled by exchanging heat in the low-temperature-side heat exchanger 14. When the heat medium cooled by the heat exchange in the low-temperature-side heat exchanger 14 flows to the cooler core 31, the cooler core 31 is cooled. Thus, moisture in air blown from the blower 140 is condensed and dehumidified by the cooler core 31. At this time, the air mix damper 150 opens the heater core passage 121. Thus, the air dehumidified by the cooler core 31 is ventilated to the heater core 21. The air ventilated to the heater core 21 is heated and blown into the vehicle cabin. As a result, the inside of the vehicle cabin is dehumidified and heated.

As described above, the proportional control three-way valve V31 can divide the heat medium having flowed through the cooler core 31 into the heat medium channel 30g as the first channel through which the heat medium having flowed through the cooler core 31 flows to the low-temperature-side heat exchanger 14 without passing through the battery temperature adjuster and the motor temperature adjuster, and the heat medium channel 30h as the second channel through which the heat medium having flowed through the cooler core 31 flows to the low-temperature-side heat exchanger 14 via the battery temperature adjuster and the motor temperature adjuster.

The proportional control three-way valve V31 changes the ratio between the amount of heat medium flowing through the heat medium channel 30g and the amount of heat medium flowing through the heat medium channel 30h according to the temperature of air blown into the vehicle cabin. That is, when the temperature of air blown into the vehicle cabin is too high, the proportional control three-way valve V31 increases the flow rate of the heat medium to the heat medium channel 30g. As a result, the flow rate of the heat medium absorbing heat in the battery 41 and the motor 51 and flowing to the low-temperature-side heat exchanger 14 decreases, and the flow rate of the heat medium flowing to the low-temperature-side heat exchanger 14 without absorbing heat in the battery 41 and the motor 51 increases. Thus, the heat medium having a low temperature flows to the cooler core 31 after the heat exchange in the low-temperature-side heat exchanger 14. As a result, since the temperature of the cooler core 31 decreases, the temperature decreases while the dehumidification amount of air blown into the vehicle cabin increases.

On the other hand, when the temperature of air blown into the vehicle cabin is too low, the proportional control three-way valve V31 increases the flow rate of the heat medium to the heat medium channel 30h. As a result, the flow rate of the heat medium absorbing heat in the battery 41 and the motor 51 and flowing to the low-temperature-side heat exchanger 14 increases, and the flow rate of the heat medium flowing to the low-temperature-side heat exchanger 14 without absorbing heat in the battery 41 and the motor 51 decreases. Thus, the heat medium having a high temperature flows to the cooler core 31 after the heat exchange in the low-temperature-side heat exchanger 14. As a result, since the temperature of the cooler core 31 increases, the temperature increases while the dehumidification amount of air blown into the vehicle cabin decreases.

In either case, the flow rate of the heat medium flowing through the cooler core 31 is kept constant, but the ratio between the heat medium having absorbed heat and the heat medium having not absorbed heat is proportionally changed by the proportional control three-way valve V31. Thus, since the temperature of the heat medium flowing through the cooler core 31 changes proportionally, a change in the blower air temperature to the inside of the vehicle cabin and a change in the dehumidification amount to the inside of the vehicle cabin when the flow division ratio of the heat medium is changed by the proportional control three-way valve V31 can be made gentle. As a result, it is possible to suppress a decrease in comfort due to the change in the blower air temperature to the inside of the vehicle cabin. In addition, since the temperature of the heat medium flowing directly from the cooler core 31 to the low-temperature-side heat exchanger 14 can be controlled proportionally by the proportional control three-way valve V31, the dehumidification amount can be easily and finely controlled.

By adjusting the amount of heat medium flowing to the battery temperature adjuster and the motor temperature adjuster by the proportional control three-way valve V31, the battery 41 and the motor 51 can be cooled while controlling the influence of the heat generation of the battery 41 and the motor 51 on the dehumidification heating operation.

### <Dehumidification Heating Operation (Appropriate Battery Temperature Range)>

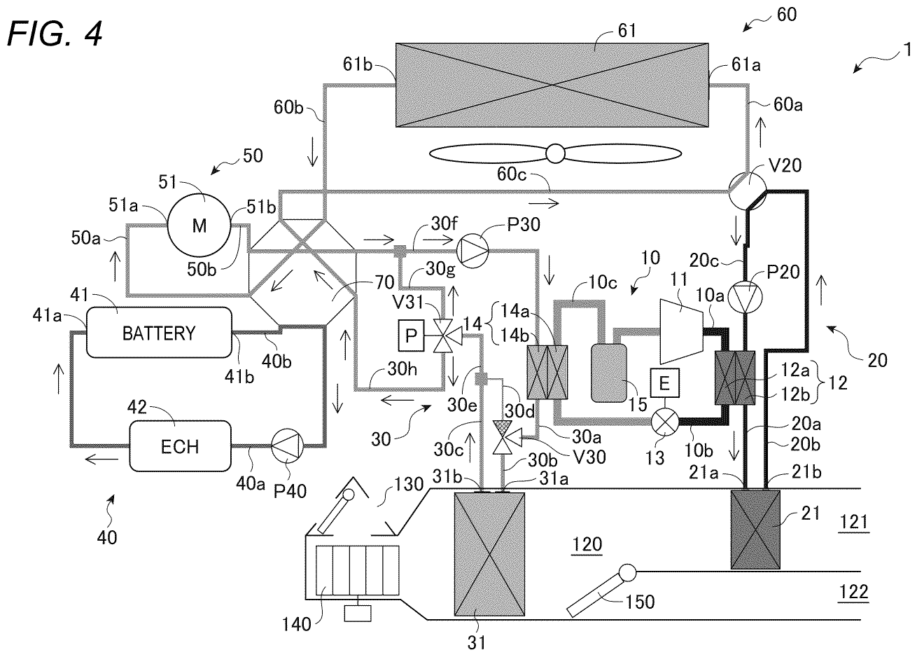

FIG. 4 shows the state of the thermal management system 1 after the warm-up of the battery 41 has been completed and the battery 41 has reached an appropriate temperature range in the dehumidification heating operation.

The high-temperature-side heat medium circuit 20 through which the heat medium having exchanged heat in the high-temperature-side heat exchanger 12 flows is set as follows. That is, the four-way valve V20 connects the heat medium channels 20b, 20c such that the heat medium heated by the heat exchange in the high-temperature-side heat exchanger 12 circulates through the high-temperature-side heat medium circuit 20 disconnected from the outdoor heat exchange circuit 60 and flows through the heater core 21. As a result, the inside of the vehicle cabin is heated by the heat of the heat medium absorbed in the high-temperature-side heat exchanger 12.

As shown in FIG. 4, in a case where the heating operation cannot be performed only by the exhaust heat of the motor 51, the low-temperature-side heat medium circuit 30 through which the heat medium subjected to heat exchange in the low-temperature-side heat exchanger 14 flows is set as follows. That is, the three-way valve V30 forms the heat medium channels 30a, 30b such that the heat medium cooled by the heat exchange in the low-temperature-side heat exchanger 14 passes through the cooler core 31.

The low-temperature-side heat medium circuit 30 through which the heat medium having exchanged heat in the low-temperature-side heat exchanger 14 flows is set as follows. That is, the three-way valve V30 forms the heat medium channels 30a, 30b such that the heat medium cooled by the heat exchange in the low-temperature-side heat exchanger 14 passes through the cooler core 31.

The channel switching device 70 connects the channels of the low-temperature-side heat medium circuit 30, the outdoor heat exchange circuit 60, and the motor temperature adjustment circuit 50, and forms a circulation path in which the low-temperature-side heat medium circuit 30, the outdoor heat exchange circuit 60, and the motor temperature adjustment circuit 50 circulate the heat medium in cooperation with each other. The proportional control three-way valve V31 forms the heat medium channels 30c, 30e, 30h such that the heat medium having flowed through the cooler core 31 passes through the radiator 61.

That is, the heat medium channels 30a, 30b, 30c, 30e, 30h, 30f of the low-temperature-side heat medium circuit 30, the heat medium channels 50a, 50b passing through the motor 51, and the heat medium channels 60c, 60a, 60b passing through the radiator 61 are connected, and the heat medium circulates through these circulation paths. As a result, the heat medium flowing from the proportional control three-way valve V31 to the heat medium channel 30h circulates via the radiator 61 and the motor temperature adjuster. Then, the heat medium having exchanged heat in the low-temperature-side heat exchanger 14 passes through the radiator 61, exchanges heat with the outside air, and absorbs the exhaust heat of the motor 51. As described above, the refrigerant circuit 10 operates using the heat of the heat medium absorbed from the motor 51 as a heat absorption source. At this time, the motor 51 is cooled.

The proportional control three-way valve V31 forms the heat medium channels 30c, 30e, 30g such that the heat medium having flowed through the cooler core 31 does not pass through the radiator 61 and the motor temperature adjuster. That is, the heat medium circulates in a circulation path including the heat medium channels 30a, 30b, 30c, 30e, 30g, 30f of the low-temperature-side heat medium circuit 30. As a result, the heat medium flowing from the proportional control three-way valve V31 to the heat medium channel 30g circulates without passing through the radiator 61 and the motor temperature adjuster. Then, the heat medium subjected to heat exchange in the low-temperature-side heat exchanger 14 flows directly to the low-temperature-side heat exchanger 14.

Then, the heat medium divided by the proportional control three-way valve V31 is joined in the heat medium channel 30f and flows to the low-temperature-side heat exchanger 14, and is cooled by exchanging heat in the low-temperature-side heat exchanger 14. When the heat medium cooled by the heat exchange in the low-temperature-side heat exchanger 14 flows to the cooler core 31, the cooler core 31 is cooled. Thus, moisture in air blown from the blower 140 is condensed and dehumidified by the cooler core 31. At this time, the air mix damper 150 opens the heater core passage 121. Thus, the air dehumidified by the cooler core 31 is ventilated to the heater core 21. The air ventilated to the heater core 21 is heated and blown into the vehicle cabin. As a result, the inside of the vehicle cabin is dehumidified and heated.

As described above, the proportional control three-way valve V31 can divide the heat medium having flowed through the cooler core 31 into the heat medium channel 30g as the first channel through which the heat medium having flowed through the cooler core 31 flows to the low-temperature-side heat exchanger 14 without passing through the motor temperature adjuster and the radiator 61, and the heat medium channel 30h as the second channel through which the heat medium having flowed through the cooler core 31 flows to the low-temperature-side heat exchanger 14 via the motor temperature adjuster and the radiator 61.

The proportional control three-way valve V31 changes the ratio between the amount of heat medium flowing through the heat medium channel 30g and the amount of heat medium flowing through the heat medium channel 30h according to the temperature of air blown into the vehicle cabin. That is, when the temperature of air blown into the vehicle cabin is too high, the proportional control three-way valve V31 increases the flow rate of the heat medium to the heat medium channel 30g. As a result, the flow rate of the heat medium absorbing heat in the motor 51 and the radiator 61 and flowing to the low-temperature-side heat exchanger 14 decreases, and the flow rate of the heat medium flowing to the low-temperature-side heat exchanger 14 without absorbing heat in the motor 51 and the radiator 61 increases. Thus, the heat medium having a low temperature flows to the cooler core 31 after the heat exchange in the low-temperature-side heat exchanger 14. As a result, since the temperature of the cooler core 31 decreases, the temperature decreases while the dehumidification amount of air blown into the vehicle cabin increases.

On the other hand, when the temperature of air blown into the vehicle cabin is too low, the proportional control three-way valve V31 increases the flow rate of the heat medium to the heat medium channel 30h. As a result, the flow rate of the heat medium absorbing heat in the motor 51 and the radiator 61 and flowing to the low-temperature-side heat exchanger 14 increases, and the flow rate of the heat medium flowing to the low-temperature-side heat exchanger 14 without absorbing heat in the motor 51 and the radiator 61 decreases. Thus, the heat medium having a high temperature flows to the cooler core 31 after the heat exchange in the low-temperature-side heat exchanger 14. As a result, since the temperature of the cooler core 31 increases, the temperature increases while the dehumidification amount of air blown into the vehicle cabin decreases.

In either case, the flow rate of the heat medium flowing through the cooler core 31 is kept constant, but the ratio between the heat medium having absorbed heat and the heat medium having not absorbed heat is proportionally changed by the proportional control three-way valve V31. Thus, since the temperature of the heat medium flowing through the cooler core 31 changes proportionally, a change in the blower air temperature to the inside of the vehicle cabin and a change in the dehumidification amount to the inside of the vehicle cabin when the flow division ratio of the heat medium is changed by the proportional control three-way valve V31 can be made gentle. As a result, it is possible to suppress a decrease in comfort due to the change in the blower air temperature to the inside of the vehicle cabin. In addition, since the temperature of the heat medium flowing directly from the cooler core 31 to the low-temperature-side heat exchanger 14 can be controlled proportionally by the proportional control three-way valve V31, the dehumidification amount can be easily and finely controlled.

In addition, by controlling the ratio of the heat medium divided by the proportional control three-way valve V31, the amount of heat absorbed in the radiator 61 can be controlled by adjusting the amount of heat medium flowing to the radiator 61. Thus, the dehumidification amount can be easily controlled even if a shutter for controlling the amount of air flowing into the radiator 61 is not provided.

By adjusting the amount of heat medium flowing to the motor temperature adjuster by the proportional control three-way valve V31, the motor 51 can be cooled while controlling the influence of the heat generation of the motor 51 on the dehumidification heating operation.

Note that the channel switching device 70 causes the battery temperature adjustment circuit 40 to independently form the circulation path of the heat medium. Since the battery 41 also generates heat, the temperature of the battery 41 is adjusted by adjusting the flow rate of the heat medium circulating through the battery temperature adjustment circuit 40. At this time, the heat medium may be heated by the heat medium heating device 42 if necessary.

### System

The thermal management system 1 according to the present embodiment can divide the heat medium having flowed through the cooler core 31 into the heat medium channel 30g through which the heat medium having flowed through the cooler core 31 flows to the low-temperature-side heat exchanger 14 without passing through the battery temperature adjuster, the motor temperature adjuster, and the radiator 61, and the heat medium channel 30h through which the heat medium having flowed through the cooler core 31 flows to the low-temperature-side heat exchanger 14 via the battery temperature adjuster, the motor temperature adjuster, and the radiator 61. Thus, the flow rate of the heat medium flowing through the cooler core 31 is kept constant, but the ratio between the heat medium having absorbed heat and the heat medium having not absorbed heat when flowing through the cooler core 31 is proportionally changed by the proportional control three-way valve V31. Thus, since the temperature of the heat medium flowing through the cooler core 31 also changes proportionally, a change in the blower air temperature to the inside of the vehicle cabin and a change in the dehumidification amount to the inside of the vehicle cabin when the flow division ratio of the heat medium is changed by the proportional control three-way valve V31 can be made gentle. As a result, it is possible to suppress a decrease in comfort due to the change in the blower air temperature to the inside of the vehicle cabin. In addition, since the temperature of the heat medium flowing directly from the cooler core 31 to the low-temperature-side heat exchanger 14 can be controlled proportionally by the proportional control three-way valve V31, the dehumidification amount can be easily and finely controlled.

Since the thermal management system 1 according to the present embodiment adjusts the amount of heat medium flowing to the radiator 61 by controlling the ratio of the heat medium divided by the proportional control three-way valve V31 to control the amount of heat absorbed in the radiator 61, the dehumidification amount can be easily controlled even without a shutter that controls the amount of air flowing into the radiator 61.

Since the thermal management system 1 according to the present embodiment adjusts the amount of heat medium flowing to the motor temperature adjuster by controlling the ratio of the heat medium divided by the proportional control three-way valve V31, the motor 51 can be cooled while controlling the temperature of the heat medium flowing to the cooler core 31 even if the motor 51 generates heat.

### Modification of Second Embodiment

A modification of the second embodiment will be described. Note that in the present modification, detailed description of configurations similar to those described in the second embodiment will be omitted. In the present modification, the proportional control three-way valve V31 shown in FIG. 2 is not provided in the low-temperature-side heat medium circuit 30, but is provided in the outdoor heat exchange circuit 60. As a result, the configurations of the heat medium channels of the low-temperature-side heat medium circuit 30 and the outdoor heat exchange circuit 60 are different from those in FIG. 2 as follows.

### <Low-Temperature-Side Heat Medium Circuit>

The elements of the low-temperature-side heat medium circuit 30 are connected by heat medium channels 30a, 30b, 30c, 30d, 30e, 30f. The outlet of the heat medium passage 14b of the low-temperature-side heat exchanger 14 and the three-way valve V30 are connected by the heat medium channel 30a, and the three-way valve V30 and the inlet side 31a of the cooler core 31 are connected by the heat medium channel 30b. When the three-way valve V30 connects these heat medium channels 30a, 30b, the outlet of the heat medium passage 14b of the low-temperature-side heat exchanger 14 and the inlet side 31a of the cooler core 31 are connected. The outlet side 31b of the cooler core 31 is connected to the channel switching device 70 via the heat medium channel 30c connected thereto, a junction point, and the heat medium channel 30e downstream thereof.

The three-way valve V30 and the junction point are connected by the heat medium channel 30d. When the cooler core 31 is disconnected by the three-way valve V30 and the outlet of the heat medium passage 14b of the low-temperature-side heat exchanger 14 and the channel switching device 70 are connected by the heat medium channels 30a, 30d, 30e, a bypass channel bypassing the cooler core 31 is formed.

The heat medium channel 30f connects the channel switching device 70 and the inlet of the heat medium passage 14b of the low-temperature-side heat exchanger 14. The heat medium circulates in the low-temperature-side heat medium circuit 30 by the circulation pump P30 placed on the path of the heat medium channel 30f. When passing through the heat medium passage 14b of the low-temperature-side heat exchanger 14, the heat medium is cooled by discharging heat to the refrigerant circuit 10. The cooled heat medium can be supplied to the cooler core 31 from the inlet side 31a and pass through the cooler core 31. At this time, the heat medium absorbs heat in the cooler core 31, whereby the cooler core 31 can function. The heat medium discharged from the outlet side 31b after having passed through the cooler core 31 or the heat medium having bypassed the cooler core 31 then passes through at least any one of the battery temperature adjustment circuit 40, the motor temperature adjustment circuit 50, or the outdoor heat exchange circuit 60 connected via the channel switching device 70, and flows again toward the heat medium passage 14b of the low-temperature-side heat exchanger 14.

### <Outdoor Heat Exchange Circuit>

The elements of the outdoor heat exchange circuit 60 are connected by the heat medium channels 60a, 60b, 60c, 60d, 60e. The inlet side 61a of the radiator 61 is connected to the four-way valve V20 by the heat medium channel 60a. The outlet side 61b of the radiator 61 is connected to the channel switching device 70 by the heat medium channel 60b. The four-way valve V20 and the proportional control three-way valve V31 are connected by the heat medium channel 60c. When the four-way valve V20 connects these two heat medium channels 60a, 60c, the inlet side 61a of the radiator 61 is connected to the proportional control three-way valve V31. The proportional control three-way valve V31 and the channel switching device 70 are connected by the heat medium channel 60d. The proportional control three-way valve V31 is connected to the channel switching device 70 via the heat medium channel 60e, the junction point, and the heat medium channel 60e downstream thereof.

The outdoor heat exchange circuit 60 can be disconnected from and independent of other circuits by the channel switching device 70. The channel of the outdoor heat exchange circuit 60 is connected to the channel of at least any one of the low-temperature-side heat medium circuit 30, the battery temperature adjustment circuit 40, or the motor temperature adjustment circuit 50 by the channel switching device 70, and can form the circulation path for circulating the heat medium in cooperation with at least any one of these circuits.

### <Dehumidification Heating Operation (Startup/Below Appropriate Battery Temperature Range)>

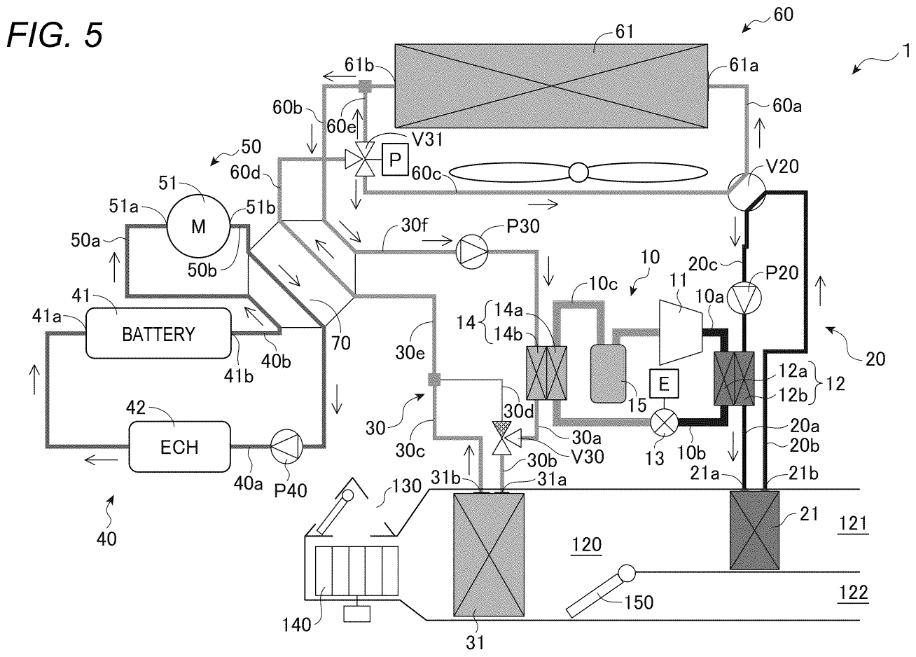

FIG. 5 shows the state of the thermal management system 1 at the time of startup in the dehumidification heating operation.

The high-temperature-side heat medium circuit 20 is set similarly to FIG. 2.

The low-temperature-side heat medium circuit 30 is set as follows. That is, the three-way valve V30 forms the heat medium channels 30a, 30b such that the heat medium cooled by the heat exchange in the low-temperature-side heat exchanger 14 passes through the cooler core 31. The channel switching device 70 connects the channels of the low-temperature-side heat medium circuit 30 and the outdoor heat exchange circuit 60 to each other, and forms the circulation path in which the low-temperature-side heat medium circuit 30 and the outdoor heat exchange circuit 60 cooperate to circulate the heat medium. The proportional control three-way valve V31 forms the heat medium channels 60c, 60e such that the heat medium having flowed through the cooler core 31 passes through the radiator 61.

That is, the heat medium channels 30a, 30b, 30c, 30e, 30f of the low-temperature-side heat medium circuit 30 and the heat medium channels 60a, 60b, 60c of the outdoor heat exchange circuit 60 are connected, and the heat medium circulates through these circulation paths. As a result, the heat medium divided from the proportional control three-way valve V31 and flowing to the heat medium channel 60c circulates via the radiator 61. As a result, the heat medium having exchanged heat in the low-temperature-side heat exchanger 14 passes through the radiator 61, and exchanges heat with the outside air. As described above, the refrigerant circuit 10 operates using the heat of the heat medium absorbed from the outside air in the radiator 61 as a heat absorption source.

The proportional control three-way valve V31 forms the heat medium channels 60d, 60e, 60b such that the heat medium having flowed through the cooler core 31 does not pass through the radiator 61. That is, the heat medium circulates in the circulation path including the heat medium channels 60d, 60e, 60b of the outdoor heat exchange circuit 60 and the heat medium channels 30a, 30b, 30c, 30e, 30f of the low-temperature-side heat medium circuit 30. As a result, the heat medium flowing from the proportional control three-way valve V31 to the heat medium channel 60e circulates without passing through the radiator 61. Then, the heat medium subjected to heat exchange in the low-temperature-side heat exchanger 14 flows directly to the low-temperature-side heat exchanger 14.

Then, the heat medium divided by the proportional control three-way valve V31 is joined in the heat medium channel 60b and flows to the low-temperature-side heat exchanger 14 from the heat medium channel 30f, and is cooled by exchanging heat in the low-temperature-side heat exchanger 14. Since the heat medium cooled by the heat exchange in the low-temperature-side heat exchanger 14 flows to the cooler core 31, the cooler core 31 is cooled. Thus, moisture in air blown from the blower 140 is condensed and dehumidified by the cooler core 31. At this time, the air mix damper 150 opens the heater core passage 121. Thus, the air dehumidified by the cooler core 31 is ventilated to the heater core 21. The air ventilated to the heater core 21 is heated and blown into the vehicle cabin. As a result, the inside of the vehicle cabin is dehumidified and heated.

As described above, when the outdoor heat exchange circuit 60 and the low-temperature-side heat medium circuit 30 are connected, the proportional control three-way valve V31 can divide the heat medium having flowed through the cooler core 31 into the heat medium channel 60e as the first channel through which the heat medium having flowed through the cooler core 31 flows to the low-temperature-side heat exchanger 14 without passing through the radiator 61, and the heat medium channel 60c as the second channel through which the heat medium having flowed through the cooler core 31 flows to the low-temperature-side heat exchanger 14 via the radiator 61.

The proportional control three-way valve V31 changes the ratio between the amount of heat medium flowing through the heat medium channel 60e and the amount of heat medium flowing through the heat medium channel 60c according to the temperature of air blown into the vehicle cabin. That is, when the temperature of air blown into the vehicle cabin is too high, the proportional control three-way valve V31 increases the flow rate of the heat medium to the heat medium channel 60e. As a result, the flow rate of the heat medium absorbing heat in the radiator 61 and flowing to the low-temperature-side heat exchanger 14 decreases, and the flow rate of the heat medium flowing to the low-temperature-side heat exchanger 14 without absorbing heat in the radiator 61 increases. Thus, the heat medium having a low temperature flows to the cooler core 31 after the heat exchange in the low-temperature-side heat exchanger 14. As a result, since the temperature of the cooler core 31 decreases, the temperature decreases while the dehumidification amount of air blown into the vehicle cabin increases.

On the other hand, when the temperature of air blown into the vehicle cabin is too low, the proportional control three-way valve V31 increases the flow rate of the heat medium to the heat medium channel 60c. As a result, the flow rate of the heat medium absorbing heat in the radiator 61 and flowing to the low-temperature-side heat exchanger 14 increases, and the flow rate of the heat medium flowing to the low-temperature-side heat exchanger 14 without absorbing heat in the radiator 61 decreases. Thus, the heat medium having a high temperature flows to the cooler core 31 after the heat exchange in the low-temperature-side heat exchanger 14. As a result, since the temperature of the cooler core 31 increases, the temperature increases while the dehumidification amount of air blown into the vehicle cabin decreases.

In either case, the flow rate of the heat medium flowing through the cooler core 31 is kept constant, but the ratio between the heat medium having absorbed heat and the heat medium having not absorbed heat is proportionally changed by the proportional control three-way valve V31. Thus, since the temperature of the heat medium flowing through the cooler core 31 changes proportionally, a change in the blower air temperature to the inside of the vehicle cabin and a change in the dehumidification amount to the inside of the vehicle cabin when the flow division ratio of the heat medium is changed by the proportional control three-way valve V31 can be made gentle. As a result, it is possible to suppress a decrease in comfort due to the change in the blower air temperature to the inside of the vehicle cabin. In addition, since the temperature of the heat medium flowing directly from the cooler core 31 to the low-temperature-side heat exchanger 14 can be controlled proportionally by the proportional control three-way valve V31, the dehumidification amount can be easily and finely controlled.

In addition, by controlling the ratio of the heat medium divided by the proportional control three-way valve V31, the amount of heat absorbed in the radiator 61 can be controlled by adjusting the amount of heat medium flowing to the radiator 61. Thus, the dehumidification amount can be easily controlled even if a shutter for controlling the amount of air flowing into the radiator 61 is not provided.

### Others, Modifications of Second Embodiment

Note that when the dehumidification heating operation is performed in the vehicle cabin, instead of the proportional control three-way valve V60 in the thermal management system 1 of FIG. 1 described in the first embodiment, an on-off valve of which the opening degree is adjustable is provided in each of the heat medium channels 60c, 20c, 50a, so that effects similar to those of a case where the proportional control three-way valve V31 is provided can be obtained.

The thermal management system 1 of the present embodiment can achieve the following effects.

(1) The proportional control three-way valve V31 can divide the heat medium having flowed through the cooler core 31 into the heat medium channel 30g through which the heat medium having flowed through the cooler core 31 flows to the low-temperature-side heat exchanger 14 without passing through the battery temperature adjuster, the motor temperature adjuster, and the radiator 61, and the heat medium channel 30h through which the heat medium having flowed through the cooler core 31 flows to the low-temperature-side heat exchanger 14 via the battery temperature adjuster, the motor temperature adjuster, and the radiator 61.

With this configuration, the flow rate of the heat medium flowing through the cooler core 31 is kept constant, but the ratio between the heat medium having absorbed heat and the heat medium having not absorbed heat is proportionally changed by the proportional control three-way valve V31. Thus, since the temperature of the heat medium flowing through the cooler core 31 changes proportionally, a change in the blower air temperature to the inside of the vehicle cabin and a change in the dehumidification amount to the inside of the vehicle cabin when the flow division ratio of the heat medium is changed by the proportional control three-way valve V31 can be made gentle. As a result, it is possible to suppress a decrease in comfort due to the change in the blower air temperature to the inside of the vehicle cabin. In addition, since the temperature of the heat medium flowing directly from the cooler core 31 to the low-temperature-side heat exchanger 14 can be controlled proportionally by the proportional control three-way valve V31, the dehumidification amount can be easily and finely controlled.

(2) By controlling the ratio of the heat medium divided by the proportional control three-way valve V31, the amount of heat medium flowing to the radiator 61 is adjusted.

Thus, the amount of heat absorbed in the radiator 61 can be controlled, and therefore, the dehumidification amount can be easily controlled even if a shutter for controlling the amount of air flowing into the radiator 61 is not provided.

(3) The amount of heat medium flowing to the battery temperature adjuster and the motor temperature adjuster is adjusted by the proportional control three-way valve V31.

With this configuration, the battery 41 and the motor 51 can be cooled while controlling the influence of the heat generation of the battery 41 and the motor 51 on the dehumidification heating operation.

Although the present invention has been described with reference to the preferred embodiments, the present invention is not limited only to the above-described embodiments, and it goes without saying that various modifications can be made within the scope of the present invention.

### LIST OF REFERENCE SIGNS

1 Thermal management system
10 Refrigerant circuit
11 Compressor
12 High-temperature-side heat exchanger
13 Decompression device
14 Low-temperature-side heat exchanger
15 Accumulator
20 High-temperature-side heat medium circuit
21 Heater core
V20 Four-way valve
30 Low-temperature-side heat medium circuit
31 Cooler core
P30 Circulation pump
30 Three-way valve
V31 Proportional Control Valve
40 Battery temperature adjustment circuit
41 Battery
P40 Circulation pump
50 Motor temperature adjustment circuit
V50 Three-way valve
51 Motor
60 Outdoor heat exchange circuit
P60 Circulation pump
V60 Proportional Control Valve
61 Radiator
70 Channel switching device
100 HVAC unit
110 Case
120 Air flow passage
121 Heater core passage
122 Bypass passage
150 Air mix damper

1. A thermal management system comprising:
a refrigerant circuit configured to circulate refrigerant and including a compressor, a high-temperature-side heat exchanger, a decompression device, and a low-temperature-side heat exchanger;
a high-temperature-side heat medium circuit including a heater core that heats air supplied into a vehicle cabin and configured to circulate a heat medium capable of exchanging heat with the refrigerant via the high-temperature-side heat exchanger;
a low-temperature-side heat medium circuit including a cooler core that cools air supplied into the vehicle cabin and configured to circulate a heat medium capable of exchanging heat with the refrigerant via the low-temperature-side heat exchanger;
a heat absorbing target heat exchange circuit including a heat exchanger for a heat absorbing target and configured to circulate a heat medium; and
a channel switching device configured to switch the low-temperature-side heat medium circuit and the heat absorbing target heat exchange circuit between a connection state and an independent state, wherein
the low-temperature-side heat medium circuit includes a flow divider for a heat medium, which is disposed downstream of the cooler core, and
when a dehumidification heating operation is performed in the vehicle cabin,
in the high-temperature-side heat medium circuit, a heat medium circulates between the high-temperature-side heat exchanger and the heater core,
the channel switching device connects the low-temperature-side heat medium circuit and the heat absorbing target heat exchange circuit, and
the flow divider is capable of dividing a heat medium having flowed through the cooler core into a first channel through which the heat medium having flowed through the cooler core flows to the low-temperature-side heat exchanger without passing through the heat exchanger for the heat absorbing target and a second channel through which the heat medium having flowed through the cooler core flows to the low-temperature-side heat exchanger via the heat exchanger for the heat absorbing target.

2. The thermal management system according to claim 1, wherein
the heat exchanger for the heat absorbing target is a radiator.

3. The thermal management system according to claim 1, wherein
the heat exchanger for the heat absorbing target is an in-vehicle heat generating device temperature adjuster that adjusts a temperature of an in-vehicle heat generating device.
